(19) United States
(12) Patent Application Publication
(10) Pub. No.: US 2026/0069384 A1
(43) Pub. Date: Mar. 12, 2026

(54) IMAGE-BASED DETERMINATION OF DENTAL APPLIANCE FIT

(71) Applicant: Align Technology, Inc., San Jose, CA (US)

(72) Inventors: Christopher E. Cramer, Durham, NC (US); Chad Clayton Brown, Cary, NC (US)

(21) Appl. No.: 19/325,028

(22) Filed: Sep. 10, 2025

Related U.S. Application Data
(60) Provisional application No. 63/693,402, filed on Sep. 11, 2024.

(51) Int. Cl. A61C 7/08; A61C 7/00; G06F 30/20; G06T 7/00; G06T 7/11; G06T 7/12; G06T 11/00; G06T 17/00

(52) U.S. Cl. CPC A61C 7/08; A61C 7/002; G06F 30/20; G06T 7/0012; G06T 7/11; G06T 7/12; G06T 11/00; G06T 17/00; G06T 2207/30036

(57) ABSTRACT

Systems and methods for evaluating dental appliance fit are provided, including: accessing a 2D image including a depiction of a dental appliance being worn on a patient's teeth; accessing a 3D digital representation of the patient's teeth; identifying a line associated with a tooth in the 3D digital representation; projecting the line onto the tooth in the 2D image; determining a distance between an edge of the tooth in the 2D image and an edge of the dental appliance in the 2D image, based on the projected line; and outputting an indication of a fit parameter for display on a display device, where the fit parameter is based on the determined distance.

### CROSS-REFERENCE TO RELATED APPLICATION(S)

The present application claims the benefit of priority to U.S. Provisional Application No. 63/693,402, filed Sep. 11, 2024, which is incorporated by reference herein in its entirety.

### TECHNICAL FIELD

The present technology generally relates to dental treatment, and in particular, to systems and methods for determining dental appliance fit based on images.

### BACKGROUND

Dental appliances are used to treat various dental conditions, such as dental malocclusions, jaw dysfunction/misalignment, functional and/or aesthetic conditions, endodontic conditions, and others. For example, a patient's teeth can be repositioned using a series of dental appliances that are placed successively on the teeth to provide controlled forces to gradually move the teeth toward a desired arrangement. The efficacy of appliance-based dental treatment may be affected by how well the dental appliance fits on the patient's teeth. For instance, a poorly-fitting dental appliance may result in too little or too much force being applied to the teeth, forces being applied to the wrong teeth, and/or poor patient compliance due to the dental appliance slipping off the teeth or being difficult to seat properly on the teeth. Moreover, poor appliance fit may indicate that the patient's teeth have deviated from the movement path specified by the treatment plan. Poor appliance fit may also be attributable to quality control issues or other problems with the manufacturing of the dental appliance. Conventional approaches for checking dental appliance fit generally require an in-person appointment for the clinician to visually examine the dental appliance on the patient's teeth, which may be inconvenient for the patient and may not provide accurate information on the extent and location of fit issues.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram illustrating a method for evaluating dental appliance fit, in accordance with embodiments of the present technology.

FIG. 2A illustrates a representative example of a 2D image depicting a patient's teeth with dental appliances thereon, in accordance with embodiments of the present technology.

FIG. 2B illustrates tooth regions and space regions in the 2D image of FIG. 2A, in accordance with embodiments of the present technology.

FIG. 2C illustrates a 3D digital representation of a patient's teeth, in accordance with embodiments of the present technology.

FIG. 2D illustrates the 2D image of FIG. 2A with a plurality of projected lines from the 3D digital representation of FIG. 2C, in accordance with embodiments of the present technology.

FIG. 2E illustrates the 2D image of FIG. 2D with the projected lines at initial locations relative to the teeth, in accordance with embodiments of the present technology.

FIG. 2F illustrates the 2D image of FIG. 2E after adjustments to the projected lines, in accordance with embodiments of the present technology.

FIG. 2G illustrates distance measurements obtained using the projected lines in the 2D image of FIG. 2F, in accordance with embodiments of the present technology.

FIG. 3 is a flow diagram illustrating a method for determining a distance between an edge of a tooth and an edge of a dental appliance based on a projected line, in accordance with embodiments of the present technology.

FIG. 4A illustrates a portion of a 2D image depicting a tooth, a dental appliance, and a projected line, in accordance with embodiments of the present technology.

FIG. 4B illustrates the 2D image of FIG. 4A after the projected line has been extended, in accordance with embodiments of the present technology.

FIG. 4C illustrates measurement of the intersection of the extended projected line of FIG. 4B with the space region of the dental appliance, in accordance with embodiments of the present technology.

FIG. 5 is a flow diagram illustrating a method for evaluating dental appliance fit, in accordance with embodiments of the present technology.

FIG. 6 is a 2D image of a patient's tooth including a dental auxiliary, in accordance with embodiments of the present technology.

FIG. 7A illustrates a representative example of a tooth repositioning appliance configured in accordance with embodiments of the present technology.

FIG. 7B illustrates a tooth repositioning system including a plurality of appliances, in accordance with embodiments of the present technology.

FIG. 7C illustrates a method of orthodontic treatment using a plurality of appliances, in accordance with embodiments of the present technology.

FIG. 8 illustrates a method for designing an orthodontic appliance, in accordance with embodiments of the present technology.

FIG. 9 illustrates a method for digitally planning an orthodontic treatment and/or design or fabrication of an appliance, in accordance with embodiments of the present technology.

### DETAILED DESCRIPTION

The present technology relates to systems and methods for evaluating fit of a dental appliance on a patient's teeth. In some embodiments, for example, a method for evaluating dental appliance fit includes accessing a 2D image (e.g., a photograph) including a depiction of a dental appliance being worn on a patient's teeth. The method can also include accessing a 3D digital representation of the patient's teeth (e.g., a digital model depicting the patient's teeth in a tooth arrangement specified by a treatment plan for the patient's teeth), and identifying a line associated with a tooth in the 3D digital representation. The method can further include projecting the line onto the tooth in the 2D image. Based on the projected line, a distance between an edge of the tooth in the 2D image and an edge of the dental appliance in the 2D image can be determined. The method can continue with outputting an indication of a fit parameter for display on a display device, where the fit parameter is based on the determined distance.

The present technology can provide various advantages compared to conventional techniques for evaluating dental appliance fit. For example, conventional techniques generally require the patient to be evaluated by a clinician in person, which can be time-consuming and inconvenient for the patient. Moreover, the clinician may assess fit based solely on a visual examination and/or feedback from the patient, which may not provide accurate results and/or may not be capable of identifying the precise locations of fit issues. Image-based approaches can address some of these concerns, e.g., by allowing dental appliance fit to be evaluated from patient images rather than requiring an in-person visit and/or by providing a more objective and accurate assessment of fit. However, image-based approaches still present many challenges. For instance, it may be difficult to correctly assign each region of the dental appliance in the image to its corresponding tooth for purposes of measuring dental appliance fit at that particular tooth. This issue may be particularly significant for regions of the dental appliance that are close to multiple teeth, e.g., the interproximal regions. Moreover, the accuracy of the fit measurement may depend on the location at which the measurement is taken, e.g., certain regions of the dental appliance may include features that may confound accurate fit measurements and/or may not be clinically relevant to fit, such as extra clearance to accommodate tooth movements. Furthermore, the pixel-to-distance conversion for different teeth in the image may vary according to the distance of the teeth from the camera (e.g., teeth that are farther away from the camera are smaller in the resulting image than teeth that are closer to the camera), and conventional techniques for evaluating appliance fit may not be capable of accounting for such differences.

The present technology can address these and other challenges by using one or more clinically relevant features of the dental anatomy as reference elements for measuring dental appliance fit, thereby providing more consistent and accurate fit measurements. These clinically relevant features can be obtained from a preexisting 3D digital representation of the patient's teeth, such as one or more 3D digital representations of tooth arrangements corresponding to various treatment stages in the patient's dental treatment plan. This approach can provide some or all of the following advantages: (1) the clinically relevant feature can be used to identify the appropriate region of the dental appliance for the fit measurement, thereby obviating the need to assign each region of the dental appliance in the image to a corresponding tooth; (2) the clinically relevant feature can be selected so that fit measurements are taken at a location on the teeth away from dental appliance features that may result in inaccurate and/or non-clinically relevant measurements; and/or (3) the clinically relevant feature can be used to determine a pixel-to-distance conversion on a per-tooth basis, thereby providing greater per-tooth measurement accuracy.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Evaluation of Dental Appliance Fit

The present technology provides systems and methods for evaluating how well a dental appliance fits on a patient's teeth. The dental appliance can be, for example, one of a series of dental appliances (e.g., aligners, palatal expanders) that are successively worn on the patient's teeth to reposition the teeth or a dental anatomy from an initial tooth arrangement toward a target tooth arrangement in accordance with a dental treatment plan. As another example, the dental appliance can be configured to maintain the patient's teeth in a target tooth arrangement or protect the dentition (e.g., a retainer, a mouthguard, a night guard). Additional examples and details of dental appliances that are applicable to the present technology are provided, e.g., in Section II below.

In some situations, a dental appliance may not fit properly on the patient's teeth, e.g., it may be difficult or impossible to seat the dental appliance on the patient's teeth in the manner prescribed by the corresponding treatment stage of the dental treatment plan. For example, in embodiments where the dental appliance includes a shell having a plurality of cavities for receiving the patient's teeth, poor appliance fit may be present if one or more teeth do not fit properly into their corresponding cavities (e.g., there is excessive space between the occlusal surfaces of the teeth and the interior occlusal surfaces of the corresponding cavities). Poor appliance fit may be caused by deviation of the patient's teeth from the treatment plan, e.g., the dental appliance may have been designed to fit on a particular tooth arrangement prescribed by a treatment stage of the treatment plan, but the current arrangement of the patient's teeth differs significantly from the prescribed tooth arrangement. Poor appliance fit may also be attributable to manufacturing issues, e.g., the actual geometry of the dental appliance may not match the intended geometry of the dental appliance.

The efficacy of the dental treatment may be affected by how well the dental appliance fits on the patient's teeth. For instance, a poorly-fitting dental appliance may result in inadequate and/or excessive forces being applied to teeth, forces being applied in the wrong direction, forces being applied to the incorrect teeth, etc. Poor appliance fit may also result in poor patient compliance, in that the patient may be less likely to wear the dental appliance as prescribed if the dental appliance is difficult to seat properly on the teeth, keeps slipping off the teeth, is uncomfortable to wear due to fit issues, etc. Poor compliance may adversely affect treatment and may result in delayed or suboptimal treatment outcomes or even complications. Thus, early and accurate detection of appliance fit issues can be beneficial to ensure that the dental treatment is progressing as intended and/or to minimize the amount of correction needed if the patient's teeth have deviated from the treatment plan.

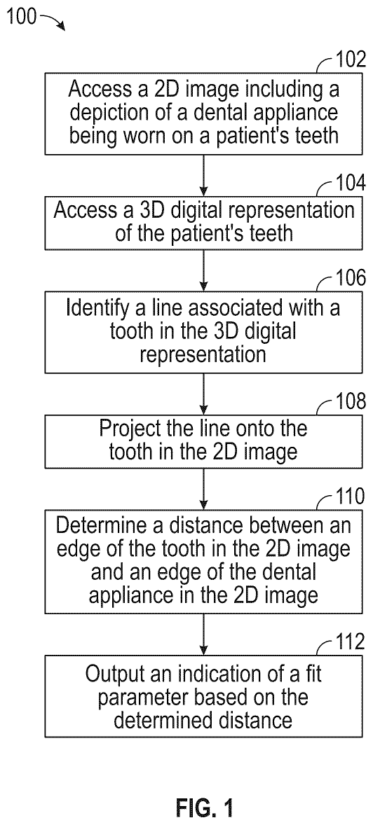

FIG. 1 is a flow diagram illustrating a method 100 for evaluating dental appliance fit, in accordance with embodiments of the present technology. The method 100 can be used to detect problems with dental appliance fit based on one or more images of the dental appliance on the patient's teeth, without requiring an in-person assessment of the patient. In some embodiments, some or all of the processes of the method 100 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety.

The method 100 can begin at block 102 with accessing a 2D image including a depiction of a dental appliance being worn on a patient's teeth. The 2D image can include any suitable image data type, such as one or more photographs, one or more frames of a video, etc. The 2D image can depict the patient from any suitable view, such as a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with jaw open, or a left buccal view with the jaw open. The view in the 2D image may be selected according to the type of dental appliance and/or the areas of the intraoral anatomy that are relevant for evaluating fit. For instance, a 2D image of an occlusal view of the upper jaw may be appropriate for evaluating fit of a palatal expander that is seated on the patient's posterior teeth.

The 2D image can be obtained using any suitable imaging device, such as a digital camera (e.g., a DSLR camera, a mirrorless camera). Optionally, the imaging device can be part of or can be operably coupled to a computing device (e.g., a mobile device such as a smartphone or tablet; a desktop device; a server). The computing device may be operated by or associated with the patient, a healthcare provider (e.g., a clinician), or other suitable user.

In some embodiments, the 2D image is obtained using the imaging device only, without assistance from any auxiliary devices. In other embodiments, however, the 2D image can be obtained using the imaging device in combination with an auxiliary device to position the imaging device in a fixed spatial location with respect to the patient's teeth and/or to retract the patient's checks and lips to improve visibility of the teeth. For example, the auxiliary device can include one or more check retractors. As another example, the auxiliary device can be a tube-type device including a smartphone interface configured to couple to a smartphone (or other mobile device with a camera), a patient interface configured to retract the patient's checks and lips, and a tubular body between the smartphone interface and the patient interface with a lumen extending therethrough, e.g., as described in U.S. Patent Application Publication No. 2022/0338723, the disclosure of which is incorporated by reference herein in its entirety. Other representative examples of systems, methods, and devices for obtaining 2D images of a patient are provided in U.S. Patent Application Publication No. 2022/0023003, the disclosure of which is incorporated by reference herein in its entirety.

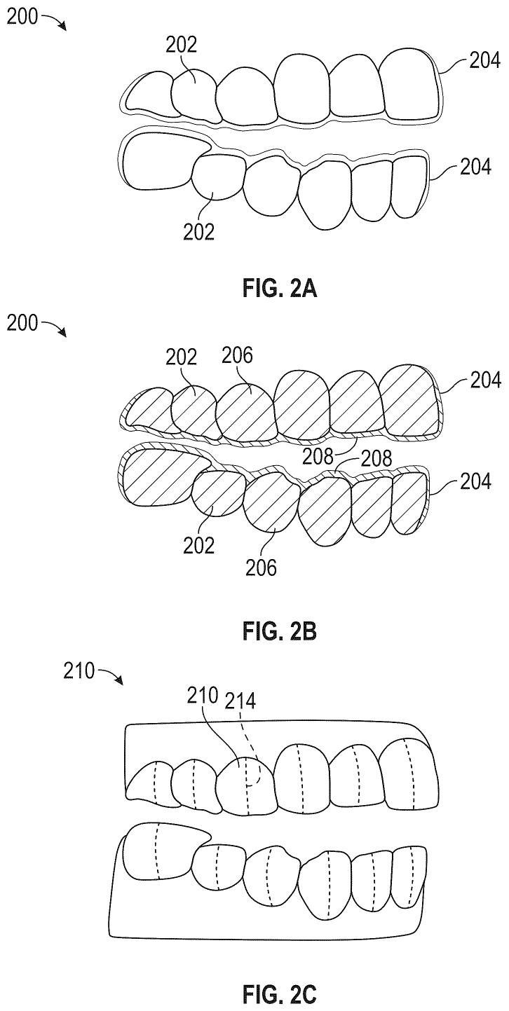

FIG. 2A illustrates a representative example of a 2D image 200 depicting a patient's teeth 202 with dental appliances 204 thereon, in accordance with embodiments of the present technology. In the illustrated embodiment, the image 200 depicts a right buccal view of the upper and lower jaws of the patient, and a pair of dental appliances 204 are worn on the teeth 202 of the upper and lower jaws, with the jaws being open so that the teeth 202 of the upper jaw are not in contact with the teeth 202 of the lower jaw. In other embodiments, however, the image 200 can depict one or both jaws from other perspectives and/or in different positions, and/or a different arrangement of dental appliances 204 can be worn (e.g., the upper appliance 204 only or the lower appliance 204 only).

Referring again to FIG. 1, the 2D image of block 102 can include identifiers or other metadata distinguishing regions of the image depicting the patient's teeth (“teeth regions”) from regions of the image depicting the portions of the dental appliance without the teeth (“space regions”). The teeth regions can include the set of pixels in the 2D image corresponding to the patient's teeth, including portions of teeth that are covered by the dental appliance and portions of the teeth that are not covered by the dental appliance. Optionally, the teeth regions can be further segmented into a plurality of individual tooth regions, with each tooth region corresponding to a respective individual tooth.

The space regions can include the set of the pixels in the 2D image corresponding to the portions of the dental appliance that do not cover any underlying teeth. For instance, the space regions can include a space between an edge of a tooth (e.g., an incisal or occlusal edge) and a corresponding edge of the dental appliance (e.g., an external incisal or occlusal edge of an external surface of the dental appliance, or an internal incisal or occlusal edge of a tooth receiving cavity of the dental appliance). In embodiments where the space region is between the edge of the tooth and an external edge of the dental appliance, the space region can correspond to the thickness of the dental appliance and the gap between the edge of the tooth and the internal edge of the corresponding cavity. In embodiments where the space region is between the edge of the tooth and an internal edge of the dental appliance, the space region can correspond to the gap between the edge of the tooth and between the edge of the tooth and the internal edge of the corresponding cavity. The size of the gap can be used to assess appliance fit, as discussed further below.

For example, FIG. 2B illustrates the 2D image 200 of the teeth 202 and dental appliances 204 with tooth regions 206 and space regions 208 denoted by different hatching, in accordance with embodiments of the present technology. As shown in FIG. 2B, the tooth regions 206 encompass the portions of the image 200 depicting the teeth 202, while the space regions 208 encompass the portions of the dental appliances 204 that are not over the teeth 202. Stated differently, the space regions 208 include pixels for the dental appliances 204 only, whereas pixels that show both the dental appliance 204 and the underlying tooth 202 are not included in the space regions 208. The space regions 208 can include the portions of the upper dental appliance 204 that are below the lower (e.g., incisal or occlusal) edges of the teeth 202 of the upper jaw, and the portions of the lower dental appliance 204 that are above the upper (e.g., incisal or occlusal) edges of the teeth 202 of the lower jaw. That is, the dental appliances 204 have a thickness that may be captured in the 2D image 200, and in some embodiments, the disclosed systems and methods may not be able to distinguish between gaps and dental appliance material and may at least initially classify the dental appliance material as being part of the respective space region 208. As will be described, this thickness can be subtracted from the measurements if a “true” measurement of the space regions 208 is required. In other embodiments, the system may be able to distinguish between gaps and dental appliance material such that the space regions 208 may be determined to not include portions of the dental appliance 204. Similarly, space regions 208 can optionally include the portions of the dental appliances 204 that are left of the leftmost edges of the teeth 202 and the portions of the dental appliances 204 that are right of the rightmost edges of the teeth 202.

Referring again to FIG. 1, the 2D image can optionally include identifiers or other metadata for other regions besides the teeth regions and the space regions, such as any of the following: gap regions corresponding to gingival portions of teeth that are not covered by the dental appliance (e.g., corresponding to a gap between the gingival edge of the dental appliance and the gingival margins of the teeth); gum regions corresponding to the patient's gingiva; appliance regions corresponding to the dental appliance, including portions that cover the teeth and portions that do not cover the teeth; auxiliary regions corresponding to a dental auxiliary mounted or adhered to the teeth (e.g., a dental attachment, button, wire, bracket) or any other suitable object otherwise present in the oral cavity (e.g., an elastic); receptacle regions corresponding to a receptacle formed in the dental appliance to receive a dental auxiliary, which may only include portions of the receptacle that do not cover the dental auxiliary; etc.

The identifiers can already be present in the image, or the identifiers can be generated as part of the method 100 (e.g., concurrently with or after the process of block 102). The identifiers can be generated by a software algorithm that analyzes the pixels in the image and assigns an appropriate identifier to each pixel. In some embodiments, the software algorithm uses semantic segmentation to classify each pixel of the image into one of a plurality of classes, with different classes corresponding to the teeth regions, individual tooth regions, space regions, etc. In some embodiments, the software algorithm may use multiple segmentation models for this task. For example, the software algorithm may use a tooth segmentation model to segment individual tooth regions and a space region model to identify space regions. Each pixel may be classified based on which class that particular pixel has the highest probability of matching. The classification may be based on one or more features, such as colors, shapes, edges, patterns, textures, etc. Semantic segmentation may be performed, for example, using a machine learning model (e.g., a neural network) that has been trained on labeled images of teeth and dental appliances. Additional details and examples of semantic segmentation techniques that may be used are provided in U.S. Patent Application Publication Nos. 2022/0023003 and 2023/0225831, the disclosures of which are incorporated by reference herein in their entirety. Other types of segmentation techniques that may alternatively or additionally be used include, for example, object segmentation, instance segmentation, and panoptic segmentation.

At block 104, the method 100 can continue with accessing a 3D digital representation of the patient's teeth. The 3D digital representation can be a solid model, surface model, mesh model, point cloud, or other digital data set depicting the 3D geometry of the teeth. In some embodiments, the 3D digital representation depicts the patient's teeth in a tooth arrangement specified by a treatment plan for the patient's teeth. In some embodiments, the 2D image is obtained during a treatment stage of the treatment plan, and the tooth arrangement depicted in the 3D digital representation is a planned tooth arrangement for the treatment stage. The planned tooth arrangement can be an initial tooth arrangement corresponding to an initial treatment stage (e.g., before any dental appliances have been worn on the teeth), an intermediate tooth arrangement corresponding to an intermediate treatment stage (e.g., after one or more dental appliance have been worn on the teeth), or a target tooth arrangement corresponding to a final or post-treatment stage (e.g., after tooth repositioning is complete).

The 3D digital representation can be generated based on data of the patient's teeth, such as photographs and/or videos (as captured on, e.g., a mobile computing device such as a smartphone, or another suitable device with a camera), scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data). In some embodiments, the data of the patient's teeth is used to generate a first 3D digital representation depicting a current and/or pre-treatment arrangement of the teeth, and the first 3D digital representation then used to generate one or more additional 3D digital representations depicting the teeth in one or more planned tooth arrangements of a dental treatment plan.

The 3D digital representation can include one or more reference elements associated with one or more of the patient's teeth. The reference element can correspond to a feature of the dental anatomy that may be relevant to evaluating dental appliance fit. For example, the reference element can correspond to an axis of a tooth, such as a facial axis of the clinical crown (FACC), a long axis, a midroot axis, or an axis extending between the midpoint of the gingival margin and the midpoint of the incisal/occlusal surface. The reference element can be or include a line (e.g., a straight line, a curved line, a curvilinear line) that is collinear with, is aligned with (e.g., parallel to), intersects, or overlaps the axis. Alternatively or in combination, reference elements with other geometries can be used, such as points, 2D shapes (e.g., polygons, planes), 3D shapes (e.g., cubes, spheres), etc. The geometry of the reference element can be selected based on the geometry of the corresponding anatomical feature, e.g., a planar reference element can be used to represent a planar anatomical feature.

The reference elements can already be present in the 3D digital representation, or the identifiers can be generated as part of the method 100 (e.g., concurrently with or after the process of block 104). For instance, the reference element can be generated by a software algorithm that analyzes the 3D features of the teeth to identify landmarks (e.g., midpoints, centroids, cusps, edges) that can be used to determine the appropriate size, shape, and location of the reference element in the 3D digital representation. Alternatively or in combination, the reference element can be generated based on user input, e.g., a clinician or technician manually sets the size, shape, and/or location in the reference element on the 3D digital representation.

At block 106, the method 100 can include identifying a line associated with a tooth in the 3D digital representation. The tooth can be any tooth that is present in both the 3D digital representation and the 2D image. Optionally, the tooth can be a tooth that is sufficiently visible in the 2D image and/or is otherwise determined to be appropriate for evaluating dental appliance fit. For instance, teeth that are obscured in the 2D image (e.g., by the patient's lips, cheeks, and/or other teeth) and/or are viewed at an oblique angle in the 2D image may not yield accurate fit measurements. In some embodiments, the tooth for the process of block 106 is at or near the center of the 2D image, whereas teeth that are at or near the sides of the 2D image (e.g., the leftmost and/or rightmost teeth in the image) are not used for the process of block 106.

The line can be a reference element corresponding to a feature of the dental anatomy relevant for evaluating appliance fit, such as an axis of the tooth (e.g., a FACC, long axis, or midroot axis). The line can be selected according to the type of fit measurement to be performed, e.g., if the fit is measured in a vertical (e.g., gingival-occlusal) direction, the line can be oriented in a vertical or substantially vertical orientation along the tooth. In some embodiments, the line is located away from portions of the tooth that may produce in a less accurate fit measurement and/or are not clinically relevant to evaluating fit (e.g., the interproximal regions of the tooth).

For example, FIG. 2C illustrates a 3D digital representation 210 (e.g., a 3D model) of a patient's teeth 212, in accordance with embodiments of the present technology. The 3D digital representation 210 can depict teeth 212 of the patient's upper jaw, lower jaw, or both jaws together. In the illustrated embodiment, each tooth 212 of the 3D digital representation 210 includes a line 214 corresponding to a FACC of the tooth 212. The line 214 can extend from a gingival edge of the tooth 212 to an occlusal or incisal edge of the tooth 212, and can be curved according to the corresponding curvature of the buccal surface of the tooth 212. In other embodiments, however, the teeth 212 may include other types of reference elements besides the lines 214 that may be used for evaluating appliance fit.

Referring again to FIG. 1, at block 108, the method 100 can include projecting the line onto the tooth in the 2D image. The projection process can involve selecting some or all of the points defining the line in the 3D representation, and then mapping the selected points to the corresponding locations on the tooth in the 2D image. In some embodiments, only the end points of the line are mapped to the 2D image, such that the projected line is a straight line connecting the end points. In other embodiments, other points besides the end points can be mapped to the 2D image (e.g., the midpoint), such that the projected line can be either a straight line or a curved line, depending on the geometry of the original line in the 3D digital representation.

For example, FIG. 2D illustrates the 2D image 200 with a plurality of projected lines 216 on the teeth 202, in accordance with embodiments of the present technology. The projected lines 216 can correspond to the lines 214 from the 3D digital representation 210 of FIG. 2C. In some embodiments, each tooth 212 of the 3D digital representation 210 is matched to a corresponding tooth 202 in the 2D image 200, and the line 214 from the tooth 212 in the 3D digital representation 210 is then projected onto the tooth 202 in the 2D image 200 to generate the projected line 216 for the tooth 202. Although FIG. 2D depicts the projected lines 216 as being straight lines (e.g., generated using gingival and occlusal end points of the curved lines 214 in the 3D digital representation 210), in other embodiments, the projected lines 216 can instead be curved lines (e.g., lines that account for the curvature of corresponding teeth).

Referring again to FIG. 1, the projection process of block 108 can be performed in many different ways. In some embodiments, the 3D digital representation is registered to the 2D image to determine a spatial mapping between the 3D reference frame (e.g., 3D coordinate space) of the 3D digital representation and the 2D reference frame (e.g., 2D coordinate space) of the 2D image, and the spatial mapping is used to project the line from the 3D digital representation into the 2D reference frame of the 2D image. The registration can be performed, for example, by matching one or more teeth in the 3D digital representation to one or more teeth in the 2D image, e.g., based on edges, shapes, location, etc. Alternatively or in combination, the registration can involve projecting the 3D digital representation into the 2D reference frame, e.g., based on knowledge of the imaging parameters for the 2D image (e.g., focal length, aperture, position and/or orientation of the imaging device used to obtain the 2D image), and/or by projecting the 3D digital representation according to a plurality of different simulated imaging parameters and selecting the set of imaging parameters that produce the greatest similarity between the projected 3D digital representation and the 2D image. Any suitable 3D to 2D registration algorithm can be used, e.g., a Ceres Solver and an optimization algorithm (e.g., a trust region optimization algorithm such as a Dogleg or Levenberg-Marquardt algorithm; a line search optimization algorithm such as Dense QR, Dense Normal Cholesky, Sparse Normal Cholesky, CGNR, Schur algorithm-based approaches; etc.).

In embodiments where the 3D digital representation is registered to the 2D image, the method 100 can optionally include evaluating a quality metric for the registration. The quality metric can be a quantitative value (e.g., a mean Intersection over Union (mIOU) value, a normalized output of a cost function associated with the registration process), a qualitative parameter, or a combination thereof. If the quality metric is sufficiently high (e.g., the quantitative value exceeds a threshold), the method 100 can proceed. If the quality metric is not sufficiently high, the method 100 can output a notification to a user (e.g., an alert that the appliance fit assessment may not be accurate due to poor registration quality). Optionally, an insufficient quality metric may result in the method 100 being terminated so that an alternative technique is used to evaluate dental appliance fit, such as any of the methods described in U.S. Pat. No. 11,985,414 and U.S. Patent Application Publication No. 2023/0225831, the disclosures of which are incorporated by reference herein in their entirety.

In some embodiments, after the line has been projected onto the tooth in the 2D image, the method 100 can optionally include adjusting a location of the projected line in the 2D image. The adjustment can be made to improve the accuracy of the fit measurement and/or to compensate for errors in registering the 3D digital representation to the 2D image. For instance, the projected line can be moved to a location on the tooth in the 2D image that is more likely to produce an accurate fit measurement and/or is a more clinically relevant location for evaluating fit. The location can be at or near the center of the tooth (e.g., the tooth centroid) and/or can be away from the interproximal regions of the tooth.

For example, FIG. 2E illustrates the 2D image 200 with the projected lines 216 at initial locations relative to the teeth 202, in accordance with embodiments of the present technology. As shown in FIG. 2E, some or all of the projected lines 216 may be offset from the centroid 218 of the respective tooth 202. This offset can occur, for example, if there are registration errors and/or if one or more of the teeth 202 in the 2D image 200 are at an oblique angle. As shown in FIG. 2F, the projected lines 216 can be adjusted to pass through the corresponding centroid 218, thereby reducing or eliminating the offset. In some embodiments, the adjustment includes horizontal translation only, without vertical translation and/or rotation. In other embodiments, however, the adjustment can alternatively or additionally include vertical translation and/or rotation.

Referring again to FIG. 1, in some embodiments, the process of block 108 involves adjusting a location of the projected line in the 2D image away from an object in the 2D image that may interfere with the accuracy of fit measurement. For instance, certain features of a dental appliance such as occlusal blocks, dental auxiliaries, receptacles for dental auxiliaries, etc., may produce inaccurate measurements since they may alter the shape of the dental appliance in a way that confounds the fit measurement process. In such embodiments, the location of the projected line may be adjusted away from the dental appliance feature, such that the projected line does not touch, intersect, or otherwise pass through the dental appliance feature. For example, the projected line may be shifted (e.g., in a mesial or distal direction) by a predetermined offset distance away from the location of the dental appliance feature. The offset direction and distance may be determined based on the type, size, and/or location of the dental appliance feature; the type, size, and/or location of the tooth; the view depicted in the 2D image; clinician preference; and so on.

For example, in embodiments where the dental appliance includes an occlusal block, dental appliance fit may be assessed only for teeth that are not proximate to the occlusal block (e.g., teeth that are mesial to and/or distal to the occlusal block). In some embodiments, the projected line for a tooth that is immediately mesial to the occlusal block may additionally be shifted in a mesial direction (e.g., to a location mesial to the tooth centroid), whereas the projected line for a tooth that is immediately distal to the occlusal block may be shifted in a distal direction (e.g., to a location distal to the tooth centroid). This approach can reduce the likelihood that the presence of the occlusal block produces an inaccurate fit measurement.

At block 110, the method 100 can continue with determining a distance between an edge of the tooth in the 2D image and an edge of the dental appliance in the 2D image, based on the projected line. The distance can be measured between an incisal or occlusal edge of the tooth, and a corresponding internal or external edge of the dental appliance (e.g., an external incisal or occlusal edge of an external surface of the dental appliance, or an internal incisal or occlusal edge of a tooth receiving cavity of the dental appliance). The distance can correlate to a gap between the edge of the tooth and the internal edge of the corresponding cavity of the dental appliance, and thus can be correlated to how well the dental appliance fits on the tooth (e.g., a large gap may be indicative of poor fit). In embodiments where the distance is measured between the edge of the tooth and an external edge of the dental appliance, this distance may include the thickness of the dental appliance together with the gap between the tooth and the dental appliance. Thus, in some embodiments, the appliance thickness (which may be known) can be subtracted from the measured distance so that the final distance value represents the gap only. In other embodiments, this subtraction may not be performed and the original measured distance may be used to determine fit.

Referring again to FIG. 1, in some embodiments, the distance in block 110 is initially determined as an image-based distance (e.g., a distance measured in image units such as pixels) and is subsequently converted to an actual distance (e.g., a real-world distance measured in spatial units such as mm). The conversion can be performed based on a pixel size (e.g., pixel-to-mm conversion) of the tooth in the 2D image. As discussed elsewhere herein, the pixel size of the tooth in the 2D image may vary according to the position of the tooth relative to the camera, in that teeth that are farther away from the camera may appear smaller in the resulting image than teeth that are closer to the camera. To compensate for these variations, the line can be used as a reference element to determine the appropriate pixel size for each tooth in the 2D image (“per-tooth pixel size”). For instance, the pixel size can be determined based on the length of the line in the 3D digital representation (e.g., in mm) and the length of the projected line in the 2D image (e.g., in pixels). The pixel size can then be used to convert image-based distance values to actual distance values for the appliance fit measurement. More information about techniques for converting pixel sizes to actual distances is disclosed in U.S. patent application Ser. No. 18/759,623, which is incorporated by reference herein in its entirety

For example, FIG. 2G illustrates distance measurements obtained using the projected lines 216 in the 2D image 200, in accordance with embodiments of the present technology. For each tooth 202, a distance between the edge of the tooth 202 and a corresponding edge of the dental appliance 204 can be determined by measuring a length of the respective projected line 216 that intersects the space region 208 in the 2D image 200. As previously described, the space region 208 can be the portions of the dental appliance 204 without underlying teeth and thus can correlate to the gaps between the teeth 202 and the dental appliance 204. In the illustrated embodiment, the projected lines 216 have been extended relative to their initial lengths (e.g., the initial lengths shown in FIG. 2F) to ensure that the projected lines 216 overlap with the space region 208. In other embodiments, however, the distance measurements may be performed without extending the projected lines 216.

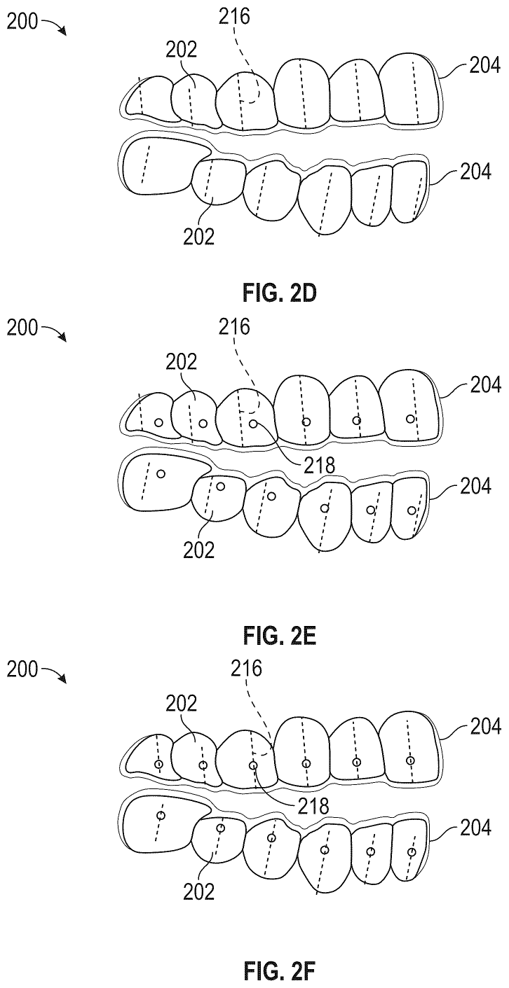

FIG. 3 is a flow diagram illustrating a method 300 for determining a distance between an edge of a tooth and an edge of a dental appliance based on a projected line, in accordance with embodiments of the present technology. The method 300 can be performed as part of the process of block 110 of the method 100 of FIG. 1.

The method 300 can begin at block 302 with defining two or more points on a projected line on a tooth in a 2D image. As described elsewhere herein, the line can be a reference element corresponding to a feature of the dental anatomy relevant for evaluating appliance fit with respect to an individual tooth, and can be projected from a 3D digital representation onto the 2D image.

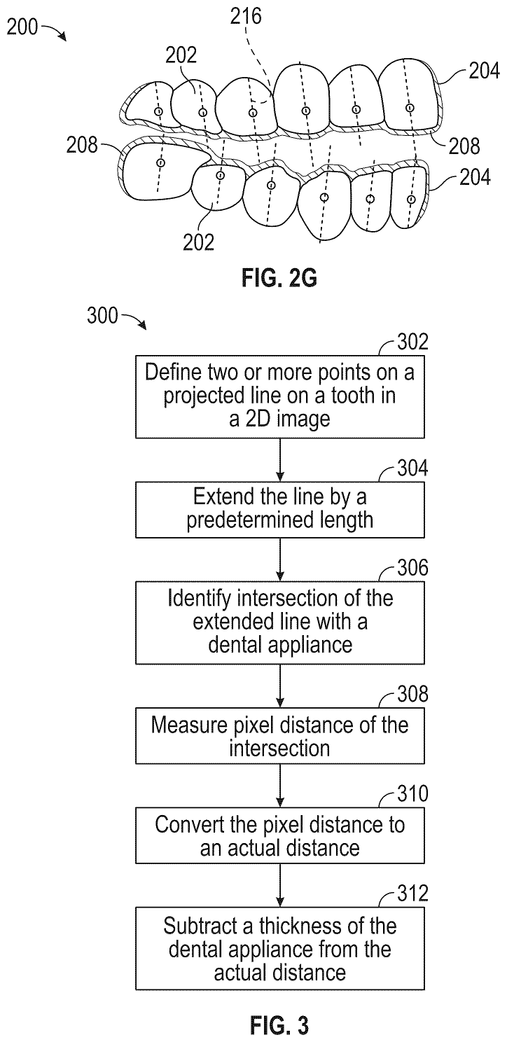

For example, FIG. 4A illustrates a portion of a 2D image depicting a tooth 202, a dental appliance 204, and a projected line 216, in accordance with embodiments of the present technology. The projected line 216 can correspond to an axis of the tooth 202, such as a FACC, long axis, midroot axis, or other axis that is in a vertical or substantially vertical orientation. The projected line 216 can be defined based on a first point representing the intersection of the projected line 216 with the gingival margin of the tooth 202 (“gingival point P₁”) and a second point representing the intersection of the projected line 216 with the incisal or occlusal edge of the tooth (“incisal/occlusal point P₂”). The projected line 216 can be used to measure the size of a space region 208 between the incisal or occlusal edge of the tooth and a corresponding incisal or gingival edge of the dental appliance 204, as discussed further below.

In some embodiments, the projected line 216 is also used to measure a per-tooth pixel size of the tooth 202. The per-tooth pixel size can be a ratio L₁/L₀, where L₁ is the length of the projected line 216 in the 2D image (in image units such as pixels), and L₀ is the length of the corresponding line in the 3D digital representation of the patient's teeth (in spatial units such as mm). As shown in FIG. 4A, the length L₁ can be measured as the number of pixels between the gingival point P₁ and the incisal/occlusal point P₂.

Referring again to FIG. 3, at block 304, the method 300 can continue with extending the line by a predetermined length. The predetermined length can be, for example, greater than or equal to 1 mm, 2 mm, 2.5 mm, 3 mm, 3.5 mm, 4 mm, or 5 mm; and/or within a range from 1 mm to 10 mm, 1 mm to 5 mm, 2.5 mm to 5 mm, 2.5 mm to 3 mm, or 3 mm to 5 mm. The predetermined length can be sufficiently long to ensure that the line will pass through the entire space region of the dental appliance proximate to the tooth. In embodiments where the 2D image depicts both jaws of the patient in close proximity to each other, the predetermined length can optionally be sufficiently short to ensure that the line will not pass through the space region of the dental appliance worn on the opposite jaw. Alternatively, the predetermined length can be selected without considering whether the line will pass through the space region of the dental appliance on the opposite jaw if it is possible to distinguish between the space region of the correct dental appliance and the space region of the other dental appliance (e.g., the space regions can be labeled with identifiers indicating which jaw and/or teeth the space region is associated with). In some embodiments, the predetermined length may be determined based on one or more locations of one or more opposing teeth on the 2D image. For example, the method may include first determining the location of a coronal (e.g., incisal/occlusal) edge of an opposing tooth that sits opposite to (e.g., a tooth of an opposing jaw) the tooth 202, and an associated predetermined length may be set such that it does not intersect the coronal edge of the opposing tooth (or that it does not intersect a point that is a threshold distance from the coronal edge of the opposing tooth). Predetermined lengths may be determined on a tooth-by-tooth basis or region-by-region basis. Alternatively, a single predetermined length may be determined for all teeth in the 2D image. Alternatively, a first predetermined length may be determined for teeth of the upper jaw and a second predetermined length may be determined for teeth of the lower jaw.

For example, FIG. 4B illustrates the projected line 216 after extension by a predetermined length, in accordance with embodiments of the present technology. In the illustrated embodiment, the projected line 216 has an initial length L₁ between the gingival point P₁ and the incisal/occlusal point P₂. The projected line 216 can be extended by a predetermined spatial length Lₛ (e.g., 3 mm). The spatial distance Lₛ can be converted to an image-based length L₂ using the formula L₂=Lₛ×L₁/L₀. An extended endpoint P₃ of the projected line 216 can then be calculated using the formula P₃=P₂+(L₂/L₁)×(P₂−P₁). As shown in FIG. 4B, the extended end point P₃ lies beyond the edge of the dental appliance 204, such that the projected line 216 now overlaps the entire length of the space region 208 between the incisal/occlusal edge of the tooth 202 and the edge of the dental appliance 204.

Referring again to FIG. 3, at block 306, the method 300 can include identifying an intersection of the extended line with the dental appliance, and at block 308, the method 300 can include measuring a pixel distance of the intersection. The intersection can be the point on the extended line that intersects the edge of the dental appliance (e.g., internal or external edge), and the pixel distance of the intersection can be the length of the extended line between the edge of the tooth and the intersection. Stated differently, the extended line can overlap the space region between the edge of the tooth and the edge of the dental appliance, and the pixel distance of the intersection can correspond to the length of the extended line that overlaps the space region.

For example, FIG. 4C illustrates measurement of the intersection of the extended projected line 216 with the space region 208 of the dental appliance 204, in accordance with embodiments of the present technology. As shown in FIG. 4C, the extended projected line 216 intersects a point P₄ on the edge of the dental appliance 204. The pixel distance of the intersection can correspond to L₃, the length of the extended projected line 216 between the incisal/occlusal point P₂ and the point P₄, which also corresponds to the length of the overlap of the extended projected line 216 with the space region 208.

Referring again to FIG. 3, at block 310, the method 300 can include converting the pixel distance to an actual distance. The conversion can be performed using the per-tooth pixel size for the tooth.

At block 312, the method 300 can optionally include subtracting a thickness of the dental appliance from the actual distance, e.g., if the actual distance obtained in block 310 includes the thickness of the dental appliance. Such a situation may occur, for instance, if the distance is measured between the edge of the tooth and the external edge of the dental appliance. The thickness of the dental appliance can be a set value (e.g., if the dental appliance has a uniform or relatively uniform thickness) or can be obtained based on appliance geometry data (e.g., based on a 3D digital representation of the dental appliance). The process of block 312 may be omitted if the actual distance obtained in block 310 does not include the thickness of the dental appliance, such as if the distance is measured between the edge of the tooth and the internal edge of the cavity of the dental appliance.

Referring back to FIG. 1, at block 112, the method 100 can include outputting an indication of a fit parameter based on the determined distance. The fit parameter can be any representation of how well the dental appliance fits on the teeth, such as a quantitative value (e.g., a score; a percentage or fraction indicating fit), a qualitative assessment, or a suitable combination thereof. For example, the fit parameter can be the determined distance, which may correlate to a gap between the tooth and the dental appliance as discussed above. As another example, the fit parameter can indicate whether the determined distance exceeds a predetermined threshold (e.g., a threshold distance value indicative of poor fit). In a further example, the fit parameter can classify the appliance fit into one or more categories based on the magnitude of the determined distance (e.g., “acceptable fit,” “unacceptable fit”)

The fit parameter in block 112 can be determined based on the distance for a single tooth or can be determined based on the distances for a plurality of teeth (which may include all of the patient's teeth that are visible in the 2D image or only a subset of the visible teeth). In the latter case, the processes of blocks 106-110 can be repeated for the plurality of teeth to determine the distance for each tooth. The resulting fit parameter can be based on the individual distance value for each tooth, and/or can include a sum, average (e.g., weighted average), score, percentage, and/or other statistics calculated from the distance values across multiple teeth. For instance, a local fit parameter indicative of how well the dental appliance fits on a particular tooth or subset of teeth (e.g., anterior teeth only, posterior teeth only) can be determined using the distance values for the particular tooth or teeth. A global fit parameter indicative of how well the dental appliance fits on all of the teeth received by the appliance can be determined using the distance values across all teeth.

The indication of the fit parameter can be presented in many different formats, such as numerically (e.g., distance values, statistics, scores), textually (e.g., categorizations, descriptive assessments, notifications), and/or graphically. In some embodiments, the output in block 112 includes a graphical representation including a heatmap or other visualization showing how the fit parameter varies across different regions of the patient's teeth and/or the dental appliance. The graphical representation can be overlaid onto the 2D image and/or the 3D digital representation of the teeth, and/or can be overlaid onto a digital representation of the dental appliance geometry. This approach can be advantageous, for example, to assist a user (e.g., the patient and/or the clinician) in identifying areas where fit issues are present.

In some embodiments, the method 100 further includes detecting whether poor appliance fit is present, e.g., by determining whether the distances for one or more teeth exceed a threshold value, whether a global fit parameter and/or a local fit parameter is unsatisfactory, etc. If poor appliance fit is detected, the method 100 can include outputting an alert to a user (e.g., the patient and/or the clinician). The alert may simply include a notification that fit issues are present or may include more details on the fit issues to assist the user in the determining the appropriate corrective action (e.g., the distance values and/or locations of fit issues).

Alternatively or in combination, the method 100 can include outputting a recommendation to the patient or to an associated healthcare provider (e.g., the doctor who is administering the dental treatment for the patient) for treatment options to address the fit issue. For example, the patient can be instructed to continue wearing a current dental appliance or to revert to wearing a previous dental appliance, e.g., if the fit issues indicate that the teeth have not progressed sufficiently toward the next treatment stage. As another example, the patient's doctor may receive a notification that the treatment is not progressing satisfactorily and may recommend an in-person visit. As another example, the patient's doctor may receive a notification recommending that a corrective dental appliance (e.g., a dental appliance that is not part of the original treatment plan and is intended to reposition teeth in an off-track arrangement back toward a prescribed arrangement) is required. The method may further recommend a modified treatment plan (e.g., specifying modified or new treatment stages and/or designs for corrective dental appliances). In such embodiments, the determined distances for one or more teeth may be used to determine the geometry for the corrective dental appliance. Optionally, the patient can be instructed to use an appliance seating device (e.g., a chewie) that the patient can bite down on to improve seating of the dental appliance on the patient's teeth. Other recommendations that can be made include instructing the patient to come in for an in-person appointment to check appliance fit, instructing the patient to take additional images of the dental appliance worn on the teeth, instructing the patient to stop wearing the dental appliances, etc. Additional details and examples of treatment recommendations that may be used with the present technology are provided in U.S. Provisional Application No. 63/608,773, the disclosure of which is incorporated by reference herein in its entirety.

The output of block 112 can be displayed on a display device, such as a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. In some embodiments, all of the processes of the method 100 are performed by the same computing device, such as a local client device. Alternatively, the processes of blocks 102-110 can be performed by a first computing device (e.g., a remote sever) and the process of block 112 can be performed by a second computing device (e.g., a local client device in communication with the remote server). In such embodiments, rather than outputting the indication of the fit parameter, the method 100 can include transmitting the indication to a display device of the second computing device for display.

The method 100 illustrated in FIG. 1 can be modified in many different ways. For example, although the above processes of the method 100 are described with respect to a single tooth, the method 100 can be used to sequentially or concurrently determine fit parameters for any suitable number of teeth. As another example, the ordering of the processes shown in FIG. 1 can be varied (e.g., the processes of block 102 may be performed after the processes of blocks 104 and 106). Some of the processes of the method 100 can be omitted and/or the method 100 can include processes not shown in FIG. 1.

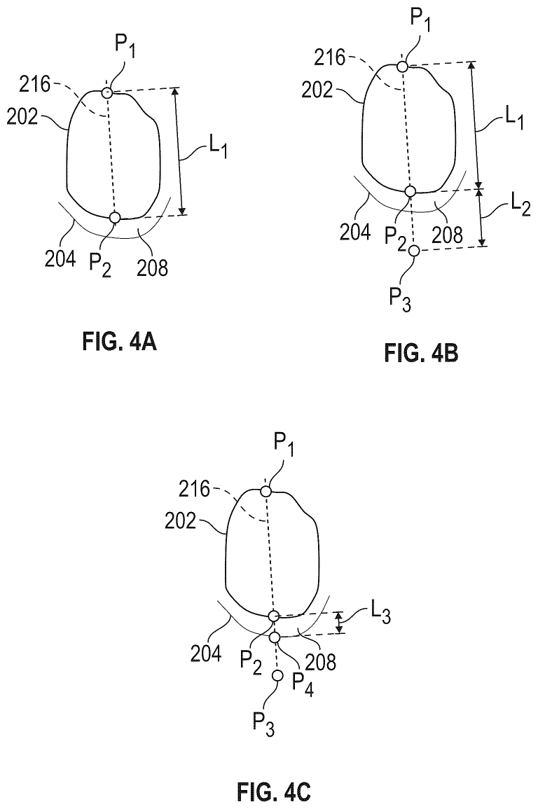

Moreover, the method 100 of FIG. 1 may be performed to evaluate dental appliance fit with respect to any number of teeth of the patient. For example, a fit parameter may be generated for each tooth in a patient's dental arch. Alternatively, a fit parameter may be determined for only a subset of the teeth in a patient's dental arch, such as the anterior teeth only, posterior teeth only, teeth that are sufficiently visible in the 2D image, teeth that exhibit little or no crowding, etc. In some embodiments, the subset of teeth for which a fit parameter is to be determined is selected based on one or more accuracy criteria relating to the likelihood that the teeth will produce an accurate fit parameter. For example, the accuracy criteria can include whether the tooth is sufficiently visible in the 2D image (e.g., most or all of the tooth is visible and not obscured by other objects), whether the tooth is free of crowding and/or overlapping by other teeth, whether the tooth is expected to produce an accurate fit measurement (e.g., certain types of teeth may consistently produce less accurate measurements than other types of teeth), whether the tooth is proximate to a portion of the dental appliance that may cause accuracy issues (e.g., features such as occlusal blocks may interfere with measurement accuracy as discussed above), the view depicted in the 2D image (e.g., a first subset of teeth may be selected if an anterior view is depicted, a second subset of teeth may be selected if a lateral view is depicted), etc. This approach may improve the accuracy and consistency of fit parameter determination. In some embodiments, a first subset of teeth of a patient may meet the accuracy criteria and a second subset of teeth of the patient may not meet the accuracy criteria required for performing some of the methods disclosed herein (but may be sufficient for a different method). In some of these embodiments, a first method (e.g., one of the methods described in detail herein) may be used to determine fit parameters for the first subset of teeth and an alternative method (e.g., as discussed below with respect to block 514 in FIG. 5) may be used to determine fit parameters for the second subset of teeth.

FIG. 5 is a flow diagram illustrating a method 500 for evaluating dental appliance fit, in accordance with embodiments of the present technology. The method 500 can be combined with any of the other methods described herein, such as the method 100 of FIG. 1 and/or the method 300 of FIG. 3. In some embodiments, some or all of the processes of the method 500 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety.

The method 500 can begin at block 502 with receiving a 2D image including a depiction of a dental appliance being worn on a patient's teeth, such as an aligner, palatal expander, retainer, etc. At block 504, the method 500 can include identifying one or more space regions in the 2D image. The space regions can be regions of the 2D image that depict the dental appliance without any underlying teeth. For instance, the space regions can include a space between the edges of the teeth and the corresponding edges of the dental appliance. At block 506, the method 500 can include identifying and segmenting teeth in the 2D image. The processes of blocks 504 and 506 can be performed in concurrently or sequentially in any suitable order, and can be performed via a semantic segmentation algorithm (e.g., a trained neural network or other machine learning model).

At block 508, the method 500 can continue with registering a 3D dental model to the segmented teeth in the 2D image. The 3D dental model can depict the patient's teeth in a tooth arrangement of a treatment stage associated with the dental appliance. The registration process can include determining a spatial mapping that projects the 3D dental model (or a portion thereof) from a 3D coordinate space into the 2D coordinate space of the 2D image.

At block 510, the method 500 can include evaluating the quality of the registration, e.g., by assessing the similarity of the projected 3D dental model to the segmented teeth in the 2D image. At block 512, the method 500 can include determining whether the registration quality is acceptable (e.g., whether the quality metric exceeds a threshold). If the registration quality is not acceptable, the method 500 can proceed to block 514 with performing an alternative fit evaluation, such as any of the methods described in U.S. Pat. No. 11,985,414 and U.S. Patent Application Publication No. 2023/0225831, the disclosures of which are incorporated by reference herein in their entirety. In some embodiments, the method may involve proceeding to block 516 for a first subset of teeth to determine fit parameters for the first subset of teeth, and proceeding to block 514 for an alternative fit evaluation for a second subset of teeth to determine fit parameters for the second subset of teeth.

If the registration quality is acceptable, the method 500 can continue to block 516 with projecting one or more FACC lines from the 3D dental model into the 2D image. Each FACC line can be projected from the 3D coordinate space of the 3D dental model into the 2D coordinate space of the 2D image and onto the corresponding tooth in the 2D image. The entire FACC line may be projected, or only certain portions may be projected (e.g., the gingival and occlusal/incisal endpoints only). As discussed previously, in some embodiments, lines other than FACC lines may be used as a reference.

At block 518, the method 500 can include determining per-tooth pixel sizes along the FACC lines. In some embodiments, the per-tooth pixel size is determined based on the length of each FACC line in the 3D dental model (in spatial units such as mm) and the length of the projected FACC line in the 2D image (in image units such as pixels).

At block 520, the method 500 can continue with aligning the FACC lines to the centroids of the teeth in the 2D image, e.g., to compensate for any registration errors that may be present.

At block 522, the method 500 can include extending the FACC lines into the space regions in the 2D image. Each FACC line may be extended by a predetermined length, e.g., a length that is sufficiently long to ensure overlap with the space regions of the dental appliance on the same jaw. Optionally, the predetermined length may be sufficiently short to avoid overlapping with the space regions of the dental appliance on the opposite jaw, if both jaws are visible in the 2D image.

At block 524, the method 500 can include measuring a pixel distance of the intersections of the extended FACC lines into the space regions. The pixel distance can correspond to the length of the extended FACC line that overlaps the space region, and thus can represent the gap between the edge of the tooth and the edge of the dental appliance.

At block 526, the method 500 can continue with converting the pixel distances to actual distances using the per-tooth pixel sizes determined in block 518. The use of per-tooth pixel sizes for the conversion may improve measurement accuracy by accounting for variations in tooth size due to distance from the camera. Optionally, the process of block 526 can further include subtracting the dental appliance thickness from the actual distances, if appropriate.

The method 500 illustrated in FIG. 5 can be modified in many different ways. For example, the ordering of the processes shown in FIG. 5 can be varied, e.g., the process of block 504 can be performed after the process of block 506 or at any other time before the process of block 522, the process of block 518 can be performed at any time before the process of block 526, etc. Some of the processes of the method 500 can be omitted, such as the processes of blocks 512, 514, and/or 520. The method 500 can include processes not shown in FIG. 5.

Although the embodiments of FIGS. 1-5 are described in connection with evaluating fit of a dental appliance on a patient's teeth, the techniques herein can be used for other applications, such as evaluating fit of a dental appliance on a dental auxiliary on a patient's teeth. A dental auxiliary can be any object that is affixed to one or more teeth and that is designed to engage a dental appliance to facilitate a dental treatment or to maintain/protect teeth, such as dental attachments, buttons, power arms, brackets, splints, distalizers, wires, etc. For example, dental attachments may be used in combination with a dental appliance (e.g., an aligner or palatal expander) to facilitate application of repositioning forces on the teeth. Dental attachments can also improve retention of a dental appliance on the teeth (e.g., palatal expanders may apply relatively large forces to expand the midpalatal suture and thus may benefit from dental attachments to prevent slipping on the teeth; retainers may require attachments in some patients for adequate engagement).

Poor fit of the dental appliance on the dental auxiliary may compromise the function of the dental auxiliary and/or may make it difficult for the patient to seat the dental appliance properly on the dental auxiliary. For example, in an aligner, if the attachments are not properly seated, they may not be engaged correctly by the aligner, resulting in suboptimal or even problematic force vectors. In a palatal expander, if the attachments are not seated correctly, the palatal expander may not be retained adequately and/or may not be engaged properly, which could also lead to suboptimal or problematic forces. For example, an improperly engaged palatal expander may result in a force vector that has an additional downward component (e.g., reducing expansionary force, tipping teeth). As another example, if the attachments on the one side are engaged properly but the attachments on the other side are not, that may cause an asymmetric skew in palatal expansion.

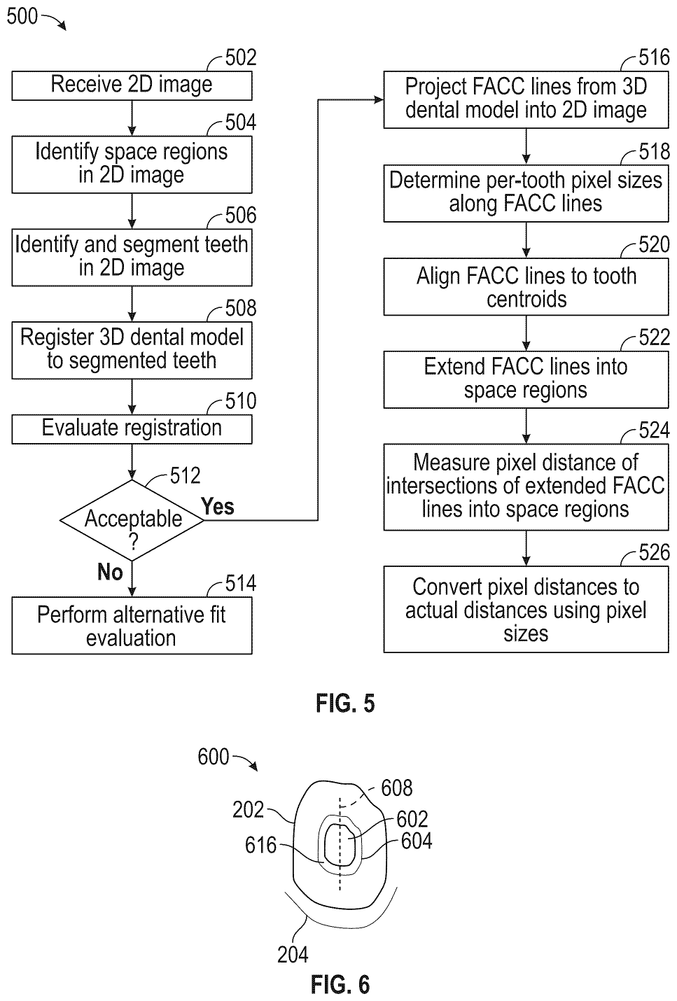

FIG. 6 is a 2D image 600 of a patient's tooth 202 including a dental auxiliary 602, in accordance with embodiments of the present technology. As shown in FIG. 6, the dental auxiliary 602 can be mounted on a tooth 202. A dental appliance 204 that is worn on the tooth 202 can include a receptacle 604 formed therein to receive and engage the dental auxiliary 602. One or more of the internal surfaces of the receptacle 604 can be configured to contact one or more corresponding external surfaces of the dental auxiliary 602 to apply forces thereto (e.g., repositioning and/or retention forces). If the dental appliance 204 does not fit properly on the dental auxiliary 602, there may be too much or too little space between the internal surfaces of the receptacle 604 and the external surfaces of the dental auxiliary 602.

In some embodiments, the fit of the dental appliance 204 on the dental auxiliary 602 can be evaluated using the methods described with respect to FIGS. 1-5, except that the evaluation is performed with respect to the dental auxiliary 602 and the receptacle 604, rather than with respect to the tooth 202 and the dental appliance 204. For instance, the 2D image 600 can be processed to identify regions depicting the dental auxiliary 602 (“dental auxiliary regions”) and regions depicting the portions of the receptacle 604 without the dental auxiliary 602 (“receptacle space regions 606”). The receptacle space regions 606 can include the space between the edge of the dental auxiliary 602 and a corresponding edge of the receptacle 604 (e.g., the internal or external edge of the receptacle 604).

A line 608 can be projected onto the dental auxiliary 602 to serve as a reference element for measuring fit. The line 608 can be obtained from a 3D digital representation of the tooth 202 and dental auxiliary 602, and may correspond to a feature of the dental auxiliary 602 that is relevant to evaluating fit. In some embodiments, for example, the line 608 corresponds to a longitudinal axis of the dental auxiliary 602. The projected line 608 may optionally be adjusted, e.g., by moving the line 608 to a centroid of the dental auxiliary 602 and/or extending the line 608 by a predetermined length to ensure that the line 608 overlaps the receptacle space regions 606. In some embodiments, the projected line 608 may not necessarily correspond to a longitudinal axis, and may instead be a vertical line that is, e.g., perpendicular to the jaw of the tooth on which the auxiliary sits, or a vertical line that corresponds to a gingival-occlusal line of the tooth.

The distance between the edge of the dental auxiliary 602 and the edge of the receptacle 604 in the 2D image can then be determined, based on the projected line. For example, the distance can be measured between an edge of the dental auxiliary 602 and a corresponding internal or external edge of the receptacle 604. The distance can correlate to a gap between the edge of the dental auxiliary 602 and the internal edge of the receptacle 604, and thus can be correlated to how well the dental appliance 204 fits on the dental auxiliary 602 (e.g., a large gap may be indicative of poor fit). In embodiments where the distance is measured between the edge of the dental auxiliary 602 and an external edge of the receptacle 604, this distance may include the thickness of the receptacle 604 together with the gap between the dental auxiliary 602 and the receptacle 604, and thus the receptacle thickness can be subtracted from the measured distance so that the final distance value represents the gap only. In some embodiments, the distance is initially determined as an image-based distance (e.g., a distance measured in image units such as pixels) and is subsequently converted to an actual distance (e.g., a distance measured in spatial units such as mm), based on a pixel size of the dental auxiliary 602 in the 2D image 600, which may be determined from the length of the line 608 in the 3D digital representation and in the 2D image 600 as described elsewhere herein.

Although certain embodiments of FIGS. 1-6 are described with respect to evaluating appliance fit using a line, this is not intended to be limiting, and other types of reference elements (e.g., points, polygons, planes, volumes) may alternatively or additionally be used. Moreover, the techniques described herein may be used in combination with other techniques for evaluating dental appliance fit, such as any of the methods described in U.S. Pat. No. 11,985,414 and U.S. Patent Application Publication No. 2023/0225831, the disclosures of which are incorporated by reference herein in their entirety.

### II. Dental Appliances and Associated Methods

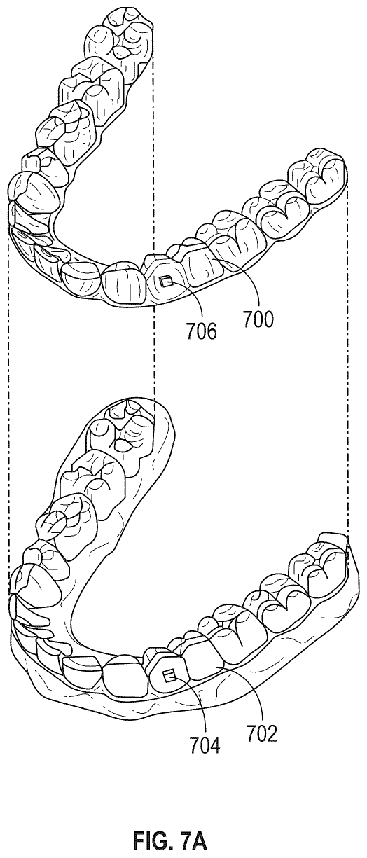

FIG. 7A illustrates a representative example of a tooth repositioning appliance 700 configured in accordance with embodiments of the present technology. The appliance 700 can be used in combination with any of the systems, methods, and devices described herein. The appliance 700 (also referred to herein as an “aligner”) can be worn by a patient in order to achieve an incremental repositioning of individual teeth 702 in the jaw. The appliance 700 can include a shell (e.g., a continuous polymeric shell or a segmented shell) having teeth-receiving cavities that receive and resiliently reposition the teeth. The appliance 700 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 700 can fit over all teeth present in an upper or lower jaw, or less than all of the teeth. The appliance 700 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 700 can be a generic appliance configured to receive the teeth, but not necessarily shaped to match the topography of the patient's teeth. In some cases, only certain teeth received by the appliance 700 are repositioned by the appliance 700 while other teeth can provide a base or anchor region for holding the appliance 700 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 700 in place over the teeth. In some cases, however, it may be desirable or necessary to provide individual attachments 704 or other anchoring elements on teeth 702 with corresponding receptacles 706 or apertures in the appliance 700 so that the appliance 700 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 7B illustrates a tooth repositioning system 710 including a plurality of appliances 712, 714, 716, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 710 can include a first appliance 712 corresponding to an initial tooth arrangement, one or more intermediate appliances 714 corresponding to one or more intermediate arrangements, and a final appliance 716 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 7C illustrates a method 720 of orthodontic treatment using a plurality of appliances, in accordance with embodiments of the present technology. The method 720 can be practiced using any of the appliances or appliance sets described herein. In block 722, a first orthodontic appliance is applied to a patient's teeth in order to reposition the teeth from a first tooth arrangement to a second tooth arrangement. In block 724, a second orthodontic appliance is applied to the patient's teeth in order to reposition the teeth from the second tooth arrangement to a third tooth arrangement. The method 720 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse (e.g., movement of individual teeth back toward their pre-corrected positions) after the repositioning method has been terminated. Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

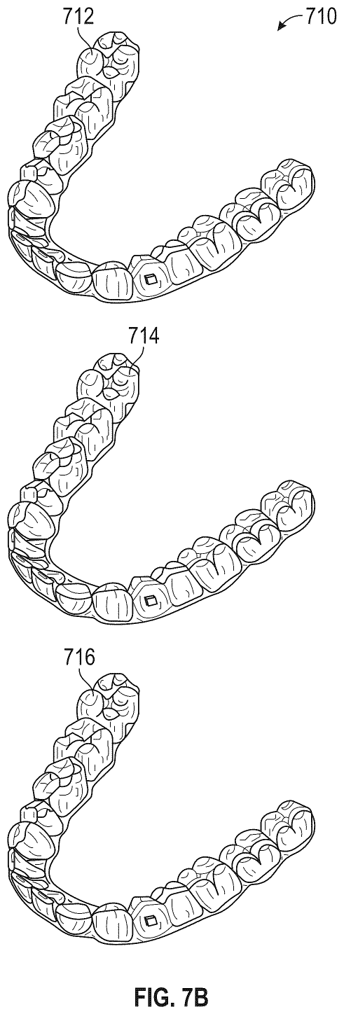

FIG. 8 illustrates a method 800 for designing an orthodontic appliance, in accordance with embodiments of the present technology. The method 800 can be applied to any embodiment of the orthodontic appliances described herein. Some or all of the steps of the method 800 can be performed by any suitable data processing system or device, e.g., one or more processors configured with suitable instructions.

In block 802, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 804, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 804 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 806, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 808, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 800 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 800 may be performed with any suitable fabrication system or device, such as the embodiments described herein. Some of the steps may be optional, e.g., the process of block 804 can be omitted, such that the orthodontic appliance is designed based on the desired tooth movements and/or determined tooth movement path, rather than based on a force system. Moreover, the order of the steps can be varied as desired.

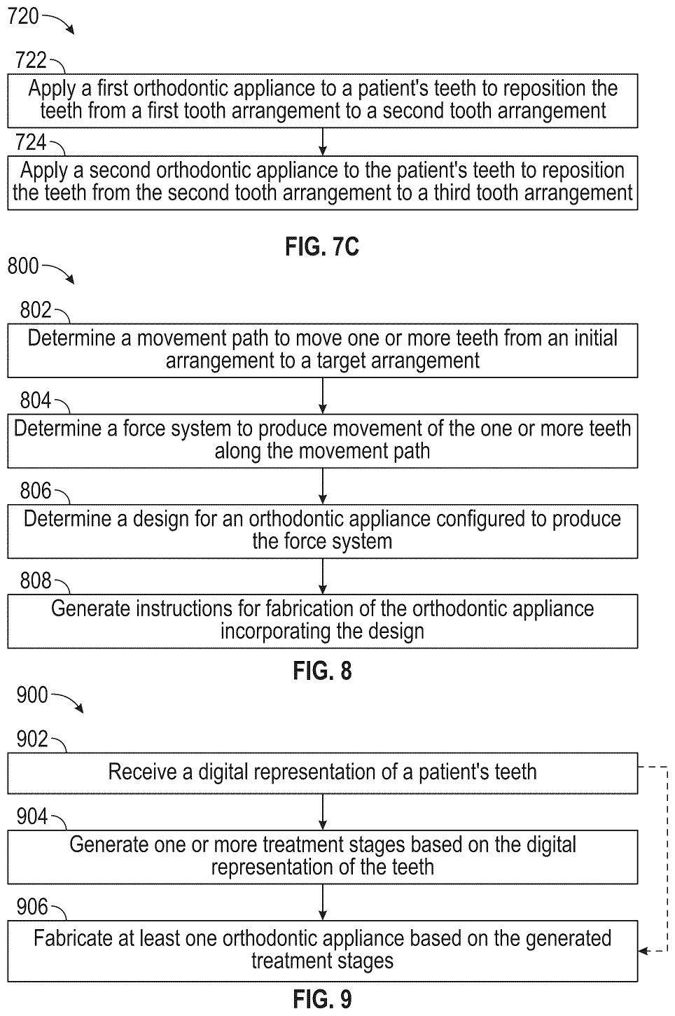

FIG. 9 illustrates a method 900 for digitally planning an orthodontic treatment and/or design or fabrication of an appliance, in accordance with embodiments. The method 900 can be applied to any of the treatment procedures described herein and can be performed by any suitable data processing system.

In block 902 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 904, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 906, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 9, design and/or fabrication of an orthodontic appliance, and perhaps a particular orthodontic treatment, may include use of a representation of the patient's teeth (e.g., including receiving a digital representation of the patient's teeth (block 902)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A system for evaluating dental appliance fit, the system comprising:
one or more processors; and
a memory operably coupled to the one or more processors and storing instructions that, when executed by the one or more processors, cause the system to perform operations comprising:
   accessing a 2D image comprising a depiction of a dental appliance being worn on a patient's teeth;
   accessing a 3D digital representation of the patient's teeth;
   identifying a line associated with a tooth in the 3D digital representation;
   projecting the line onto the tooth in the 2D image;
   determining a distance between an edge of the tooth in the 2D image and an edge of the dental appliance in the 2D image, based on the projected line; and
   outputting an indication of a fit parameter for display on a display device, wherein the fit parameter is based on the determined distance.

Example 2. The system of Example 1, wherein the line is defined by two or more points on the tooth, and wherein the operations further comprise:
extending the line by a predetermined length,
identifying an intersection of the extended line with the dental appliance in the 2D image, and
measuring a pixel distance of the intersection.

Example 3. The system of Example 2, wherein the distance is determined by:
determining a number of pixels between the two or more points on the tooth in the 2D image,
determining a pixel size for a region of the 2D image including the tooth, based on the number of pixels, and
converting the pixel distance into an actual distance based on the pixel size.

Example 4. The system of Example 3, wherein the operations further comprise subtracting a thickness of the dental appliance from the actual distance.

Example 5. The system of any one of Examples 1 to 4, wherein the operations further comprise aligning the line to a centroid of the tooth in the 2D image.

Example 5A. The system of any one of Examples 1 to 5, wherein the operations further comprise adjusting a location of the projected line on the tooth.

Example 5B. The system of Example 5A, wherein the location is adjusted away from a feature of the dental appliance that interferes with accuracy of the fit parameter.

Example 5C. The system of any one of Example 1 to 5B, wherein the operations further comprise selecting the tooth based on one or more accuracy criteria, and wherein the one or more accuracy criteria relate to a likelihood of the tooth producing an accurate fit parameter.

Example 6. The system of any one of Examples 1 to 5C, wherein the line is curved.

Example 7. The system of any one of Examples 1 to 6, wherein the line corresponds to a facial axis of the clinical crown (FACC) of the tooth.

Example 8. The system of any one of Examples 1 to 6, wherein the line corresponds to a long axis of the tooth.

Example 9. The system of any one of Examples 1 to 8, wherein the line is oriented in a vertical or substantially vertical direction.

Example 10. The system of any one of Examples 1 to 9, wherein the line is located away from an interproximal region of the tooth.

Example 11. The system of any one of Examples 1 to 10, wherein the operations further comprise projecting the 3D digital representation into a 2D reference frame of the 2D image.

Example 12. The system of Example 11, wherein the line is projected into the 2D reference frame of the 2D image.

Example 13. The system of any one of Examples 1 to 12, wherein the operations further comprise matching the tooth in the 3D digital representation to the tooth in the 2D image.

Example 14. The system of any one of Examples 1 to 13, wherein the 3D digital representation depicts the patient's teeth in a tooth arrangement specified by a treatment plan for the patient's teeth.

Example 15. The system of Example 14, wherein the 2D image is obtained during a treatment stage of the treatment plan, and the tooth arrangement depicted in the 3D digital representation is a planned tooth arrangement for the treatment stage.

Example 16. The system of Example 15, wherein the treatment stage is one of a plurality of sequential treatment stages, each treatment stage corresponding to a particular dental appliance configured to move one or more of the patient's teeth toward a target tooth arrangement.

Example 17. The system of any one of Examples 1 to 16, wherein the fit parameter comprises the determined distance.

Example 18. The system of any one of Examples 1 to 17, wherein the operations further comprise determining whether the determined distance exceeds a threshold value.

Example 19. The system of Example 18, wherein the operations further comprise, in response to a determination that the determined distance exceeds the threshold value, outputting an alert to one or more of the patient or a clinician.

Example 20. The system of Example 18 or 19, wherein the operations further comprise, in response to a determination that the determined distance exceeds the threshold value, outputting a treatment recommendation for display on the display device, wherein the treatment recommendation comprises one or more of the following: instructing the patient to continue wearing a current dental appliance, instructing the patient to revert to wearing a previous dental appliance, or instructing the patient to use a corrective dental appliance.

Example 20A. The system of any one of Examples 1 to 20, wherein the one or more processors and the memory are part of a server device, and wherein the system further comprises a client device configured to transmit the 2D image to the server device and display the indication of the fit parameter on the display device.

Example 21. The system of any one of Examples 1 to 20A, wherein the 2D image comprises a photograph or a frame of a video.

Example 22. The system of any one of Examples 1 to 21, wherein the 2D image is obtained from an imaging device that is remote from the system.

Example 23. The system of Example 22, wherein the imaging device comprises a camera that is part of or is operably coupled to a mobile device.

Example 24. The system of any one of Examples 1 to 23, wherein the system comprises the display device.

Example 25. The system of any one of Examples 1 to 23, wherein the display device is remote from the system.

Example 26. The system of any one of Examples 1 to 25, wherein the dental appliance comprises a polymeric shell having a plurality of cavities configured to receive the patient's teeth.

Example 27. The system of any one of Examples 1 to 26, wherein the dental appliance is an aligner, a retainer, or a palatal expander.

Example 28. A computer-implemented method for evaluating dental appliance fit, the computer-implemented method comprising, by one or more processors:
accessing a 2D image comprising a depiction of a dental appliance being worn on a patient's teeth;
accessing a 3D digital representation of the patient's teeth;
identifying a line associated with a tooth in the 3D digital representation;
projecting the line onto the tooth in the 2D image;
determining a distance between an edge of the tooth in the 2D image and an edge of the dental appliance in the 2D image, based on the projected line; and
outputting an indication of a fit parameter for display on a display device, wherein the fit parameter is based on the determined distance.

Example 29. The computer-implemented method of Example 28, wherein the line is defined by two or more points on the tooth, and wherein the computer-implemented method further comprises:
extending the line by a predetermined length,
identifying an intersection of the extended line with the dental appliance in the 2D image, and
measuring a pixel distance of the intersection.

Example 30. The computer-implemented method of Example 29, wherein the distance is determined by:
determining a number of pixels between the two or more points on the tooth in the 2D image,
determining a pixel size for a region of the 2D image including the tooth, based on the number of pixels, and
converting the pixel distance into an actual distance based on the pixel size.

Example 31. The computer-implemented method of Example 30, further comprising subtracting a thickness of the dental appliance from the actual distance.

Example 32. The computer-implemented method of any one of Examples 28 to 31, further comprising aligning the line to a centroid of the tooth in the 2D image.

Example 33. The computer-implemented method of any one of Examples 28 to 32, wherein the line is curved.

Example 34. The computer-implemented method of any one of Examples 28 to 33, wherein the line corresponds to a facial axis of the clinical crown (FACC) of the tooth.

Example 35. The computer-implemented method of any one of Examples 28 to 33, wherein the line corresponds to a long axis of the tooth.

Example 36. The computer-implemented method of any one of Examples 28 to 35, wherein the line is oriented in a vertical or substantially vertical direction.

Example 37. The computer-implemented method of any one of Examples 28 to 36, wherein the line is located away from an interproximal region of the tooth.

Example 38. The computer-implemented method of any one of Examples 28 to 37, further comprising projecting the 3D digital representation into a 2D reference frame of the 2D image.

Example 39. The computer-implemented method of Example 38, wherein the line is projected into the 2D reference frame of the 2D image.

Example 40. The computer-implemented method of any one of Examples 28 to 39, further comprising matching the tooth in the 3D digital representation to the tooth in the 2D image.

Example 41. The computer-implemented method of any one of Examples 28 to 40, wherein the 3D digital representation depicts the patient's teeth in a tooth arrangement specified by a treatment plan for the patient's teeth.

Example 42. The computer-implemented method of Example 41, wherein the 2D image is obtained during a treatment stage of the treatment plan, and the tooth arrangement depicted in the 3D digital representation is a planned tooth arrangement for the treatment stage.

Example 43. The computer-implemented method of Example 42, wherein the treatment stage is one of a plurality of sequential treatment stages, each treatment stage corresponding to a particular dental appliance configured to move one or more of the patient's teeth toward a target tooth arrangement.

Example 44. The computer-implemented method of any one of Examples 28 to 43, wherein the fit parameter comprises the determined distance.

Example 45. The computer-implemented method of any one of Examples 28 to 44, further comprising determining whether the determined distance exceeds a threshold value.

Example 46. The computer-implemented method of Example 45, further comprising, in response to a determination that the determined distance exceeds the threshold value, outputting an alert to one or more of the patient or a clinician.

Example 47. The computer-implemented method of Example 45 or 46, further comprising, in response to a determination that the determined distance exceeds the threshold value, outputting a treatment recommendation for display on the display device, wherein the treatment recommendation comprises one or more of the following: instructing the patient to continue wearing a current dental appliance, instructing the patient to revert to wearing a previous dental appliance, or instructing the patient to use a corrective dental appliance.

Example 48. The computer-implemented method of any one of Examples 28 to 47, wherein the 2D image comprises a photograph or a frame of a video.

Example 49. The computer-implemented method of any one of Examples 28 to 48, wherein the dental appliance comprises a polymeric shell having a plurality of cavities configured to receive the patient's teeth.

Example 50. The computer-implemented method of any one of Examples 28 to 49, wherein the dental appliance is an aligner, a retainer, or a palatal expander.

Example 51. A non-transitory computer-readable storage medium comprising instructions that, when executed by one or more processors of a computing system, cause the computing system to perform operations comprising the computer-implemented method of any one of Examples 28 to 50.

Example 52. A system for evaluating dental appliance fit, the system comprising:
one or more processors; and
a memory operably coupled to the one or more processors and storing instructions that, when executed by the one or more processors, cause the system to perform operations comprising:
   accessing a 2D image comprising a depiction of a dental appliance being worn on a patient's teeth;
   accessing a 3D digital representation of the patient's teeth, wherein the 3D digital representation comprises a reference feature for at least one tooth;
   determining a registration between the patient's teeth in the 2D image and the 3D digital representation of the patient's teeth;
   applying the reference feature for the at least one tooth in the 3D digital representation to a corresponding at least one tooth in the 2D image, based on the determined registration;
   determining a fit parameter for the dental appliance on the patient's teeth, based on the applied reference feature and the 2D image; and
   outputting an indication of the fit parameter for display on a display device.

Example 53. A system for evaluating dental auxiliary fit, the system comprising:
one or more processors; and
a memory operably coupled to the one or more processors and storing instructions that, when executed by the one or more processors, cause the system to perform operations comprising:
   accessing a 2D image comprising a depiction of a dental appliance being worn on a patient's teeth, wherein the patient's teeth include a tooth having a dental auxiliary thereon, and wherein the dental appliance includes a receptacle that receives the dental auxiliary;
   accessing a 3D digital representation of the patient's teeth including the tooth having the dental auxiliary;
   identifying a line associated with the dental auxiliary in the 3D digital representation;
   projecting the line onto the dental auxiliary in the 2D image;
   determining a distance between an edge of the dental auxiliary in the 2D image and an edge of the receptacle of the dental appliance in the 2D image, based on the projected line; and
   outputting an indication of a fit parameter for display on a display device, wherein the fit parameter is based on the determined distance.

Example 54. The system of Example 53, wherein the dental auxiliary comprises a dental attachment.

Example 55. The system of Example 53 or 54, wherein the line is defined by two or more points on the dental auxiliary, and wherein the operations further comprise:
extending the line by a predetermined length,
identifying an intersection of the extended line with the receptacle in the 2D image, and
measuring a pixel distance of the intersection.

Example 56. The system of Example 55, wherein the distance is determined by:
determining a number of pixels between the two or more points on the dental auxiliary in the 2D image,
determining a pixel size for a region of the 2D image including the dental auxiliary, based on the number of pixels, and
converting the pixel distance into an actual distance based on the pixel size.

Example 57. The system of Example 56, wherein the operations further comprise subtracting a thickness of the receptacle from the actual distance.

Example 58. A system for evaluating dental appliance fit, the system comprising:
one or more processors; and
a memory operably coupled to the one or more processors and storing instructions that, when executed by the one or more processors, cause the system to perform operations comprising:
   receiving a 2D image comprising a depiction of a dental appliance being worn on a patient's teeth;
   transmitting the 2D image to a server device;
   receiving, from the server device, an indication of a fit parameter, wherein the fit parameter is determined by:
      accessing a 3D digital representation of the patient's teeth,
      identifying a line associated with a tooth in the 3D digital representation,
      projecting the line onto the tooth in the 2D image, and
      determining a distance between an edge of the tooth in the 2D image and an edge of the dental appliance in the 2D image, based on the projected line, wherein the fit parameter is based on the determined distance; and
   displaying the indication of the fit parameter on a display device.

Example 59. The system of Example 58, wherein the 2D image comprises a photograph or a frame of a video received from an imaging device.

Example 60. The system of Example 59, wherein the imaging device comprises a camera that is part of or is operably coupled to a mobile device.

Example 61. The system of any one of Examples 58 to 60, wherein the operations further comprise, in response to a determination that the determined distance exceeds a threshold value, displaying an alert to one or more of the patient or a clinician on the display device.

Example 62. The system of Example 61, wherein the operations further comprise, in response to the determination that the determined distance exceeds the threshold value, displaying a treatment recommendation on the display device, wherein the treatment recommendation comprises one or more of the following: instructing the patient to continue wearing a current dental appliance, instructing the patient to revert to wearing a previous dental appliance, or instructing the patient to use a corrective dental appliance.

Example 63. A computer-implemented method for evaluating dental appliance fit, the computer-implemented method comprising, by one or more processors:
receiving a 2D image comprising a depiction of a dental appliance being worn on a patient's teeth;
transmitting the 2D image to a server device;
receiving, from the server device, an indication of a fit parameter, wherein the fit parameter is determined by:
   accessing a 3D digital representation of the patient's teeth,
   identifying a line associated with a tooth in the 3D digital representation,
   projecting the line onto the tooth in the 2D image, and
   determining a distance between an edge of the tooth in the 2D image and an edge of the dental appliance in the 2D image, based on the projected line, wherein the fit parameter is based on the determined distance; and
displaying an indication of the fit parameter on a display device.

Example 64. The computer-implemented method of Example 63, wherein the line is defined by two or more points on the tooth, and wherein the fit parameter is further determined by:
extending the line by a predetermined length,
identifying an intersection of the extended line with the dental appliance in the 2D image, and
measuring a pixel distance of the intersection.

Example 65. The computer-implemented method of Example 63 or 64, wherein the line corresponds to a facial axis of the clinical crown (FACC) of the tooth or to a long axis of the tooth.

Example 66. The computer-implemented method of any one of Examples 63 to 65, wherein the operations further comprise, in response to a determination that the determined distance exceeds a threshold value, displaying an alert to one or more of the patient or a clinician on the display device.

### CONCLUSION

Although many of the embodiments are described above with respect to systems, devices, and methods for evaluating dental appliance fit, the technology is applicable to other applications and/or other approaches, such as evaluating the fit of other types of medical devices. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-9.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for evaluating dental appliance fit, the system comprising:
one or more processors; and
a memory operably coupled to the one or more processors and storing instructions that, when executed by the one or more processors, cause the system to perform operations comprising:
accessing a 2D image comprising a depiction of a dental appliance being worn on a patient's teeth;
accessing a 3D digital representation of the patient's teeth;
identifying a line associated with a tooth in the 3D digital representation;
projecting the line onto the tooth in the 2D image;
determining a distance between an edge of the tooth in the 2D image and an edge of the dental appliance in the 2D image, based on the projected line; and
outputting an indication of a fit parameter for display on a display device, wherein the fit parameter is based on the determined distance.

2. The system of claim 1, wherein the line is defined by two or more points on the tooth, and wherein the operations further comprise:
extending the line by a predetermined length,
identifying an intersection of the extended line with the dental appliance in the 2D image, and
measuring a pixel distance of the intersection.

3. The system of claim 2, wherein the distance is determined by:
determining a number of pixels between the two or more points on the tooth in the 2D image,
determining a pixel size for a region of the 2D image including the tooth, based on the number of pixels, and
converting the pixel distance into an actual distance based on the pixel size.

4. The system of claim 3, wherein the operations further comprise subtracting a thickness of the dental appliance from the actual distance.

5. The system of claim 1, wherein the operations further comprise adjusting a location of the projected line on the tooth.

6. The system of claim 5, wherein the location is adjusted away from a feature of the dental appliance that interferes with accuracy of the fit parameter.

7. The system of claim 1, wherein the operations further comprise selecting the tooth based on one or more accuracy criteria, and wherein the one or more accuracy criteria relate to a likelihood of the tooth producing an accurate fit parameter.

8. The system of claim 1, wherein the line corresponds to a facial axis of the clinical crown (FACC) or a long axis of the tooth.

9. The system of claim 1, wherein the operations further comprise:
determining whether the determined distance exceeds a threshold value, and
in response to a determination that the determined distance exceeds the threshold value, outputting an alert to one or more of the patient or a clinician.

10. The system of claim 9, wherein the operations further comprise, in response to the determination that the determined distance exceeds the threshold value, outputting a treatment recommendation for display on the display device, wherein the treatment recommendation comprises one or more of the following: instructing the patient to continue wearing a current dental appliance, instructing the patient to revert to wearing a previous dental appliance, or instructing the patient to use a corrective dental appliance.

11. The system of claim 1, wherein the one or more processors and the memory are part of a server device, and wherein the system further comprises a client device configured to transmit the 2D image to the server device and display the indication of the fit parameter on the display device.

12. A system for evaluating dental appliance fit, the system comprising:
one or more processors; and
a memory operably coupled to the one or more processors and storing instructions that, when executed by the one or more processors, cause the system to perform operations comprising:
receiving a 2D image comprising a depiction of a dental appliance being worn on a patient's teeth;
transmitting the 2D image to a server device;
receiving, from the server device, an indication of a fit parameter, wherein the fit parameter is determined by:
accessing a 3D digital representation of the patient's teeth,
identifying a line associated with a tooth in the 3D digital representation,
projecting the line onto the tooth in the 2D image, and
determining a distance between an edge of the tooth in the 2D image and an edge of the dental appliance in the 2D image, based on the projected line, wherein the fit parameter is based on the determined distance; and
displaying the indication of the fit parameter on a display device.

13. The system of claim 12, wherein the 2D image comprises a photograph or a frame of a video received from an imaging device.

14. The system of claim 13, wherein the imaging device comprises a camera that is part of or is operably coupled to a mobile device.

15. The system of claim 12, wherein the operations further comprise, in response to a determination that the determined distance exceeds a threshold value, displaying an alert to one or more of the patient or a clinician on the display device.

16. The system of claim 15, wherein the operations further comprise, in response to the determination that the determined distance exceeds the threshold value, displaying a treatment recommendation on the display device, wherein the treatment recommendation comprises one or more of the following: instructing the patient to continue wearing a current dental appliance, instructing the patient to revert to wearing a previous dental appliance, or instructing the patient to use a corrective dental appliance.

17. A computer-implemented method for evaluating dental appliance fit, the computer-implemented method comprising, by one or more processors:
receiving a 2D image comprising a depiction of a dental appliance being worn on a patient's teeth;
transmitting the 2D image to a server device;
receiving, from the server device, an indication of a fit parameter, wherein the fit parameter is determined by:
accessing a 3D digital representation of the patient's teeth,
identifying a line associated with a tooth in the 3D digital representation,
projecting the line onto the tooth in the 2D image, and
determining a distance between an edge of the tooth in the 2D image and an edge of the dental appliance in the 2D image, based on the projected line, wherein the fit parameter is based on the determined distance; and
displaying an indication of the fit parameter on a display device.

18. The computer-implemented method of claim 17, wherein the line is defined by two or more points on the tooth, and wherein the fit parameter is further determined by:
extending the line by a predetermined length,
identifying an intersection of the extended line with the dental appliance in the 2D image, and
measuring a pixel distance of the intersection.

19. The computer-implemented method of claim 17, wherein the line corresponds to a facial axis of the clinical crown (FACC) of the tooth or to a long axis of the tooth.

20. The computer-implemented method of claim 17, wherein the operations further comprise, in response to a determination that the determined distance exceeds a threshold value, displaying an alert to one or more of the patient or a clinician on the display device.
